(19) United States
(12) Patent Application Publication
(10) Pub. No.: US 2025/0129277 A1
(43) Pub. Date: Apr. 24, 2025

(54) TWO-PART POLYURETHANE-(METH) ACRYLIC HYBRID ADHESIVE COMPOSITION

(71) Applicant: Henkel AG & Co. KGaA, Duesseldorf (DE)

(72) Inventors: Rory Barnes, Dublin (IE); Nigel Sweeney, Dublin (IE); Dongmei Shen, Shanghai (CN); Yongxia Wang, Bridgewater, NJ (US)

(21) Appl. No.: 18/786,680

(22) Filed: Jul. 29, 2024

Related U.S. Application Data
(63) Continuation of application No. PCT/CN2022/074878, filed on Jan. 29, 2022.

(51) Int. Cl. C09J 175/04; C09J 4/06

(52) U.S. Cl. CPC C09J 175/04; C09J 4/06; C09J 2409/00; C09J 2433/00; C09J 2475/00

(57) ABSTRACT

The present invention relates to a two-part polyurethane-(meth)acrylic hybrid adhesive composition, especially to a two-part polyurethane-(meth)acrylic hybrid adhesive composition containing a special cure system but without typical catalyst for polyurethane formation.

### TECHNICAL FIELD

The present invention relates to a two-part polyurethane-(meth)acrylic hybrid adhesive composition, especially to a two-part polyurethane-(meth)acrylic hybrid adhesive composition containing a special cure system but without typical catalyst for polyurethane formation.

### BACKGROUND OF THE INVENTION

(Meth)acrylic adhesives and polyurethane (PU) adhesives are known adhesives, and (meth)acrylic adhesives have excellent performance such as cure speed and good adhesion on various substrates but have drawbacks such as high volume shrinkage; PU adhesives have excellent chemical resistance and toughness but have drawbacks such as slow cure speed. A polyurethane-(meth)acrylic hybrid adhesive combines the advantages of (meth)acrylic adhesives and PU adhesives.

U.S. Pat. No. 8,742,020B2 relates to a polyurethane-(meth)acrylic hybrid adhesive, wherein an organoborane amine complex is contained as an initiator for curing (meth)acrylic component. Due to the pyrophoric nature of organoboranes, they must be complexed to avoid oxidative decomposition in air. Meanwhile, in order to ensure an acceptable shelf life, an excess amount of amine is used to form borane:amine complex.

US 2019/0330432A1 relates to a polyurethane-(meth)acrylic hybrid adhesive containing uretdione dimer(s) as the PU-forming component, which requires to cure at relatively high temperature of 120-200° C. due to unblocking reaction of polyuretdione. Such hybrid adhesives based on uretdione dimer(s) are not suitable for applications requiring fast cure at low temperature. Meanwhile, such hybrid adhesive compositions contain typical PU catalysts selected from dibutyltin dilaurate, zinc octoate, bismuth neodecanoate, tertiary amines, preferably 1,4-diazabicyclo[2.2.2]octane, and contains cumene hydroperoxide (CHP), polyol and dibutyltin dilaurate (DBTL) in one part, however, such combination of peroxide with DBTL is storage unstable in one part (as verified in the Example section of the present invention).

US 2014/0275345A1 also discloses a polyurethane-(meth)acrylic hybrid adhesive containing uretdione dimer(s) as the component for forming PU, which does not suitable for fast cure at low temperature.

When the hybrid adhesives are used in the electronic equipment such as mobile phones, high toughness is needed to prevent the drop failure of adhesion, meanwhile, good adhesion strength shall be maintained.

### SUMMARY OF THE INVENTION

After intensive study, the inventors surprisingly found that using a special cure system consisting of a cure accelerator and a peroxide and a copper(II) based catalyst while dispensing with typical polyurethane catalysts may achieve the above desired effects, that is, a good adhesion strength and an excellent toughness.

During the development of the invention, the inventors found that typical polyurethane catalysts e.g. organotin(IV) or tertiary amine based catalysts give reduced performance in the polyurethane-(meth)acrylic hybrid system and that copper(II) based catalysts can give optimal performance, it is believed that the copper(II) based catalysts act as both a redox cure accelerator for the (meth)acrylic component and as a catalyst for the polyurethane formation.

In view of the above findings, the present invention provides a two-part polyurethane-(meth)acrylic hybrid adhesive composition comprising, or consisting essentially of, or consisting of:
Part A):
   A1) a polyol;
   A2) a cure accelerator selected from saccharin; saccharin derivatives in which the hydrogen atom in —NH— is substituted by a hydroxyl group or an alkoxy group; toluidines, such as N,N-diethyl-p-toluidine (DE-p-T) and N,N-dimethyl-o-toluidine (DM-o-T); acetyl phenylhydrazine (APH); compounds of formulae (1) and (2); and mixtures thereof;

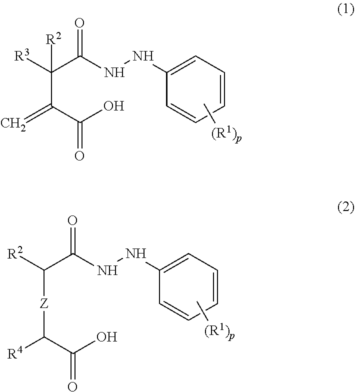

wherein R¹, R² and R³ in formula (1) and R¹, R² and R⁴ in formula (2) are each independently selected from H or C₁₋₄ alkyl; Z is a carbon-carbon single bond or carbon-carbon double bond; p is an integer of 1 to 5;
A3) a peroxide;
A4) optionally, a (meth)acrylic component;
Part B):
   B1) a polyisocyanate,
   B2) a copper (II) based catalyst,
   B3) optionally, a (meth)acrylic component.
provided that the (meth)acrylic component is present in part A only, or in part B only or in both part A and part B.

In another aspect, the present invention provides a method of bonding substrates together using the adhesive composition of the present invention.

In another aspect, the present invention provides an article bonded with the cured product of the adhesive composition of the present invention.

In still another aspect, the present invention provides use of a cure system in a two-part polyurethane-(meth)acrylic hybrid adhesive composition, wherein the cure system comprises a cure accelerator and a peroxide in one part and a copper (II) based catalyst in the other part.

The advantages of the present invention include at least: 1) a good adhesion strength can be achieved while dispensing with typical PU catalysts, 2) excellent toughness of the adhesive can be achieved.

### DETAILED DESCRIPTION OF THE INVENTION

It is to be understood by one of ordinary skill in the art that the present discussion is a description of exemplary embodiments only and is not intended as limiting the broader aspects of the present invention. Each aspect so described may be combined with any other aspect(s) unless clearly indicated to the contrary. In particular, any feature indicated as being preferred or advantageous may be combined with any other feature or features indicated as being preferred or advantageous.

Unless specified otherwise, as used herein, the terms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements or process steps.

The term “consisting essentially of” as used herein means that the listed components constitute main body of the composition, for example, at least 80% by weight of the composition, at least 85% by weight of the composition, or at least 90% by weight of the composition, and other unlisted component(s) will not affect the effects of the composition.

The term “consisting of” as used herein is close-ended and exclude additional, non-recited members, elements or process steps.

The term “(meth)acrylic” used herein intends to mean both “acrylic” and “methacrylic”.

The term “at least one” or “one or more” used herein to define a component refers to the type of the component, and not to the absolute number of molecules. For example, “one or more monomers” means one type of monomer or a mixture of a plurality of different monomers.

The term “polyol” is meant to include materials having an average of two or more hydroxyl groups per molecule.

The terms “about”, “around” and the like used herein in connection with a numerical value refer to the numerical value±10%, preferably ±5%. All numerical values herein should be interpreted as being modified by the term “about”.

Unless specified otherwise, the recitation of numerical end points includes all numbers and fractions subsumed within the respective ranges, as well as the recited end points.

All references cited in the present specification are hereby incorporated by reference in their entirety.

Unless otherwise defined, all terms used in the present invention, including technical and scientific terms, have the meaning as commonly understood by one of the ordinary skilled in the art to which this invention belongs.

Hereinafter the two-part polyurethane-(meth)acrylic hybrid adhesive composition will be described in detail.

### Part A

### A1) Polyol

As the first essential component of part A, one or more polyols are contained.

Polyol(s) will become part of the final PU network via reaction with polyisocyanate, and conventional polyols used for forming PU adhesives can be used herein without particular limitation, for example, polyester polyols, polyether polyols, or low molecular weight polyols.

Suitable polyester polyols include, for example, the reaction products of polyhydric, preferably dihydric alcohols (optionally in the presence of trihydric alcohols), with polyvalent, preferably divalent, carboxylic acids. Instead of using the free carboxylic acids, it is also possible to use the corresponding polycarboxylic acid anhydrides or corresponding polycarboxylic acid esters of lower alcohols or mixtures thereof for producing the polyesters. The polycarboxylic acids may be aliphatic, cycloaliphatic, aromatic, and/or heterocyclic and may be unsaturated or substituted, for example, by halogen atoms.

Suitable polyether polyols may be prepared by the reaction of suitable starting compounds which contain reactive hydrogen atoms with alkylene oxides such as, for example, ethylene oxide, propylene oxide, butylene oxide, styrene oxide, tetrahydrofuran, epichlorohydrin, and mixtures thereof. Suitable starting compounds containing reactive hydrogen atoms include compounds such as, for example, ethylene glycol, propylene glycol, butylene glycol, hexanediol, octanediol, neopentyl glycol, cyclohexanedimethanol, 2-methyl-1,3-propanediol, 2,2,4-trimethyl-1,3-pentanediol, triethylene glycol, tetraethylene glycol, polyethylene glycol, dipropylene glycol, polypropylene glycol, dibutylene glycol, polybutylene glycol, glycerine, trimethylolpropane, pentaerythritol, water, methanol, ethanol, 1,2,6-hexane triol, 1,2,4-butane triol, trimethylolethane, mannitol, sorbitol, methyl glycoside, sucrose, phenol, resorcinol, hydroquinone, 1,1,1- or 1,1,2-tris-(hydroxyphenyl)-ethane, etc.

Suitable low molecular weight polyols for example include ethylene glycol, 1,2- and 1,3-propanediol, isomeric butanediols, neopentyl glycol, 1,6-hexanediol, 2-methyl-1,3-propanediol, 2,2,4-trimethyl-1,3-pentanediol, 2-n-butyl-2-ethyl-1,3-propanediol, glycerol monoalkanoates (such as for example glycerol monostearates), dimer fatty alcohols, diethylene glycol, triethylene glycol, tetraethylene glycol, 1,4-dimethylolcyclohexane, dodecanediol, alkoxylated bisphenol A, hydrogenated bisphenol A, 1,3-hexanediol, 1,3-octanediol, 1,3-decandiol, 3-methyl-1,5-pentanediol, 3,3-dimethyl-1,2-butanediol, 2-methyl-1,3-pentanediol, 2-methyl-2,4-pentanediol, 3-hydroxymethyl-4-heptanol, 2-hydroxymethyl-2,3-dimethyl-1-pentanol, glycerol, trimethylolethane, trimethylolpropane, timer fatty alcohols, isomeric hexanetriols, sorbitol, pentaerythritol, ditrimethylolpropane, dipentaerythritol, diglycerol and 4,8-bis(hydroxymethyl)-tricyclo[5.2.02-6]-decane (TCD alcohol).

The polyol(s) can be contained in the Part A in an amount of from 10 to 70% by weight, preferably from 30 to 60% by weight, such as, 15%, 20%, 25%, 28%, 35%, 40%, 45%, 50%, 55% by weight, based on the total weight of Part A.

### A2) Cure Accelerator

As the second essential component of part A, one or more cure accelerators specified as below are contained.

The cure accelerator that can be used in the present invention is selected from:
saccharin,
saccharin derivatives in which the hydrogen atom in —NH— is substituted by a hydroxyl group or an alkoxy group,
toluidines, such as N,N-diethyl-p-toluidine and N,N-dimethyl-o-toluidine,
acetyl phenylhydrazine (APH),
compounds of formulae (1) to (2),

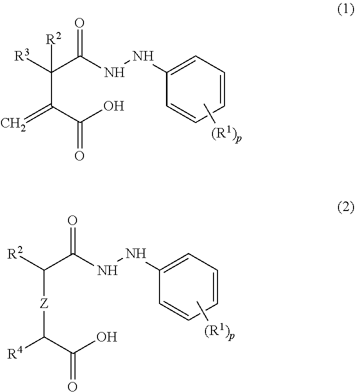

wherein R¹, R² and R³ in formula (1) and R¹, R² and R⁴ in formula (2) are each independently selected from H or C₁₋₄ alkyl; Z is a carbon-carbon single bond or carbon-carbon double bond; p is an integer between 1 and 5;
and mixtures thereof.

Specifically, particular examples of such accelerators within formulae (1) and (2) include:

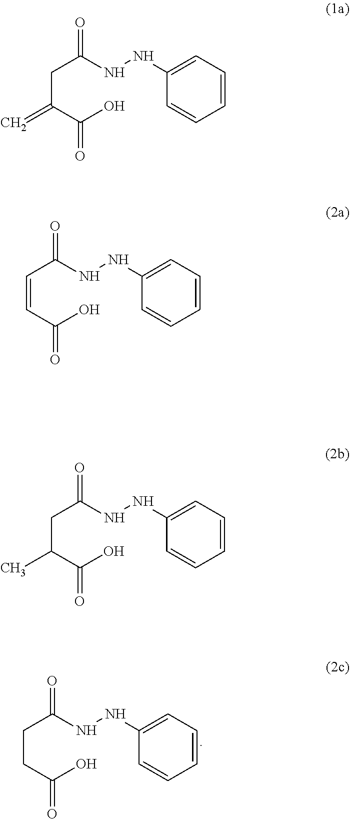 [SMILES: C=C(CC(=O)NNc1ccccc1)C(=O)O ; O=C(O)/C=C\C(=O)NNc1ccccc1 ; CC(CC(=O)NNc1ccccc1)C(=O)O ; O=C(O)CCC(=O)NNc1ccccc1]

The cure accelerator is an ingredient of the special cure system of the present invention, and can contain one or more above listed compounds. Preferably, saccharin and APH can be used in combination as the cure accelerator of the present invention.

The cure accelerator can be contained in Part A in an amount of from 0.2 to 5% by weight, preferably from 0.3 to 2% by weight, such as, 0.4%, 0.6%, 0.8%, 1.0%, 1.2%, 1.5%, 2.5%, 3.0%, 3.5%, 4.0%, 4.5% by weight, based on the total weight of Part A.

### A3) Peroxide

The peroxide is an ingredient of the special cure system of the present invention, and can act as an oxidant in the redox system for initiating the polymerization reaction of the (meth)acrylic component. One or more peroxides specified as below can be used in the present invention.

Peroxides which can be used for the purposes of the present invention are preferably organic peroxides with the general formula R—O—O—R′, R and R′ being independently an organic radical; examples of the peroxide include sulphonyl peroxides, such as acetyl cyclohexane sulphonyl peroxide; percarbonates, such as dicyclohexyl peroxy dicarbonate; di-n-butyl peroxy dicarbonate and diisopropyl peroxy dicarbonate; peresters, such as tert-butyl peroxy pivalate, tert-butyl perneodecanoate and tert-butyl perbenzoate; diacyl peroxides, such as bis-(3,3,5-trimethylhexanoyl)-peroxide; dilauroyl peroxide; didecanoyl peroxide, dipropionyl peroxide; bis-(2,4-dichlorobenzoyl)-peroxide and dibenzoyl peroxide; dialkyl peroxides, such as dicumyl peroxide and di-tert-butyl peroxide; ketal peroxides, such as 1,1-di-tert-butyl peroxy-3,3,5-trimethyl cyclohexane; alkyl hydroperoxides, such as cumene hydroperoxide, paramethane hydroperoxide and tert-butyl hydroperoxide, and ketone peroxides, such as cyclohexanone peroxide and ethyl methyl ketone peroxide.

The peroxide(s) can be contained in Part A in an amount of from 0.1 to 5% by weight, preferably from 0.5 to 3% by weight, such as, 0.3%, 0.7%, 1.0%, 1.2%, 1.4%, 1.6%, 1.8%, 2.0%, 2.2%, 2.4%, 2.6%, 2.8%, 3.0%, 3.5%, 4.0%, 4.5% by weight, based on the total weight of Part A.

### A4) (Meth)Acrylic Component

As an optional component of part A, if present, one or more (meth)acrylic compounds can be contained.

The (meth)acrylic component can comprise (meth)acrylic acid(s) and/or (meth)acrylate(s) conventionally used to form adhesives, and there is no specific limitation. For example, the (meth)acrylic component can comprise a mono-functional (meth)acrylic monomer and/or a multi-functional (meth)acrylic monomer.

The mono-functional (meth)acrylic monomer intends to mean a monomer carrying one (meth)acryloyl group, and the multi-functional (meth)acrylic monomer intends to mean a monomer carrying more than one (meth)acryloyl group, for example, carrying two to six (meth)acryloyl groups.

In the present invention, types of the mono-functional (meth)acrylic monomers and the multi-functional (meth)acrylic monomers are not particularly limited and the conventionally used ones can be used in the adhesive composition.

Examples of the mono-functional (meth)acrylic monomer may include but are not limited to: (meth)acrylic acid, n-butyl (meth)acrylate, 2-butyl (meth)acrylate, t-butyl (meth)acrylate, isobutyl (meth)acrylate, hexyl (meth)acrylate, 2-ethylhexyl (meth)acrylate, ethyl (meth)acrylate, methyl (meth)acrylate, n-propyl (meth)acrylate, isopropyl (meth)acrylate, pentyl (meth)acrylate, n-octyl (meth)acrylate, isooctyl (meth)acrylate, 2-methylbutyl (meth)acrylate, n-nonyl (meth)acrylate, isononyl (meth)acrylate, isoamyl (meth)acrylate, n-decyl (meth)acrylate, isodecyl (meth)acrylate, isobornyl (meth)acrylate, 4-methyl-2-pentyl (meth)acrylate, dodecyl (meth)acrylate, lauryl (meth)acrylate, tetrahydrofurfuryl (meth)acrylate, 2-ethoxylethyl (meth)acrylate, 2-phenoxyethyl (meth)acrylate, 2-methoxyethyl (meth)acrylate and allyl (meth)acrylate; 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, and hydroxyalkylene (having 2 to 4 carbon atoms) glycol (meth)acrylate such as 2-hydroxyethyleneglycol (meth)acrylate and 2-hydroxypropyleneglycol (meth)acrylate.

Examples of the multi-functional (meth)acrylic monomer include but are not limited to: di-functional (meth)acrylic monomers such as 1,3-butanediol di(meth)acrylate, 1,4-butanediol di(meth)acrylate, 1,6-hexanediol di(meth)acrylate, 2-butyl-2-ethyl-1,3-propanediol di(meth)-acrylate, 1,9-nonanediol di(meth)acrylate, ethylene glycol di(meth)acrylate, bisphenol A-ethylene glycol di(meth)acrylate, diethylene glycol di(meth)acrylate, triethylene glycol di(meth)-acrylate, tetraethylene glycol di(meth)acrylate, propylene glycol di(meth)acrylate, dipropylene glycol di(meth)acrylate, tripropylene glycol di(meth)acrylate, neopentyl glycol di(meth)acrylate, dicyclopentanyl di(meth)acrylate, caprolactone-modified dicyclopentenyl di(meth)acrylate, di(acryloxyethyl)isocyanurate, allylated cyclohexyl di(meth)acrylate, dimethylol dicyclopentane di(meth)acrylate, neopentylglycol-modified trimethylolpropane di(meth)acrylate, adamantine di(meth)acrylate, tricyclodecanedimethanol di(meth)acrylate, etc.; tri-functional monomers such as trimethylolpropane tri(meth)acrylate, pentaerythritol tri(meth)acrylate, dipentaerythritol tri(meth)acrylate, propylene oxide-modified trimethylolpropane tri(meth)acrylate, tris(acryloxy-ethyl)isocyanurate, etc.; 4-functional monomers such as pentaerythritol tetra(meth)acrylate, ditrimethylolpropane tetra(meth)acrylate, tetramethylolpropane tetra(meth)acrylate, etc.; 5-functional monomers such as dipentaerythritol penta(meth)acrylate; 6-functional monomers such as dipentaerythritol hexa(meth)acrylate, or the like.

The (meth)acrylic component is an essential component of the adhesive composition, but it can be present in part A only, in part B only, or in both part A and part B. The total amount of the (meth)acrylic component can be 20-65 wt %, preferably 30-55 wt %, such as 25 wt %, 35 wt %, 40 wt %, 45 wt %, 50 wt %, 60 wt %, based on the total weight of the adhesive composition. The (meth)acrylic compound can be used alone or in mixtures in each part.

If present in part A, the (meth)acrylic component can be contained in an amount of from 5 to 65% by weight, such as, 6%, 8%, 10%, 12%, 15%, 18%, 20%, 25%, 28%, 30%, 35%, 38%, 45%, 50%, 55%, 60% by weight, based on the total weight of Part A.

### Part B

### B1) Polyisocyanate

The polyisocyanate in part B) can react with the polyol in part A), forming a PU network. The polyisocyanates conventionally used for PU adhesives can be used in the present invention without particular limitation. One or more polyisocyanates can be contained in the present invention.

The term “polyisocyanate” means two or more isocyanate groups are contained in the molecule.

Examples of the polyisocyanates suitable herein for example include alkylene diisocyanates, cycloalkylene diisocyanates, aromatic diisocyanates and aliphatic-aromatic diisocyanates. Specific examples of suitable isocyanate-containing compounds include, but are not limited to, ethylene diisocyanate, ethylidene diisocyanate, propylene diisocyanate, butylene diisocyanate, trimethylene diisocyanate, hexamethylene diisocyanate, toluene diisocyanate, cyclopentylene-1,3-diisocyanate, cyclo-hexylene-1,4-diisocyanate, cyclohexylene-1,2-diisocyanate, 4,4′-diphe nylmethane diisocyanate, 2,2-diphenylpropane-4,4′-diisocyanate, xylylene diisocyanate, 1,4-naphthylene diisocyanate, 1,5-naphthylene diisocyanate, m-phenylene diisocyanate, p-phenylene diisocyanate, diphenyl-4,4′-diiso cyanate, azobenzene-4,4′-diisocyanate, diphenylsulphone-4, 4′-diisocyanate, 2,4-tolylene diisocyanate, dichlorohexam ethylene diisocyanate, furfurylidene diisocyanate, 1-chlorobenzene-2,4-diisocyanate, 4,4′,4″-triisocyanatotriphenylmethane, 1,3,5-triisocyanato-benzene, 2,4,6-triiso cyanato-toluene, 4,4′-dimethyldiphenyl-methane-2,2′,5,5-tetratetraisocyanate, isophorone diisocyante, methyenebisphenyldiisocyanate (MDI), hydrogenated MDI, poly-MDI, polyester containing diisocyanates, polycarbonate containing diisocyanates, polyethylene glycol containing diisocyanates, polypropylene glycol containing diisocyanates, polytetramethyleneglycol ether containing diisocyanates, polycaprolactone containing diisocyanates and polyether containing diisocyanates and the like.

The polyisocyanate(s) can be contained in Part B in an amount of from 20 to 75% by weight, preferably from 30 to 55% by weight, such as, 25%, 35%, 40%, 45%, 50%, 60%, 65%, 70% by weight, based on the total weight of Part B.

### B2) Copper (II) Based Catalyst

The copper (II) based catalyst is an ingredient of the special cure system of the present invention, and can act as a reductant in the redox system for initiating the polymerization reaction of the (meth)acrylic component, and also can catalyze the PU formation reaction. One or more copper (II) based catalysts can be contained in part B.

Examples of the copper (II) based catalyst for example include copper (II) complexes, such as, copper trifluoroacetylacetonate, copper hexafluoroacetylacetonate, copper acetylacetonate, copper napthenate, copper octoate, copper tetrafluoroborate, copper salicyclate, copper sulfate, copper chloride, copper bromide, copper fluoride, copper methacrylate and copper triflate.

The copper (II) based catalyst can be contained in Part B in an amount of from 1 to 5000 ppm, preferably from 20 to 200 ppm, such as, 30, 40, 50, 60, 70, 80, 90, 100, 120, 140, 160, 180, 220, 250, 300, 350, 400, 450, 500, 550, 600, 650, 700 ppm, based on the total weight of Part B.

### B3) (Meth)Acrylic Component

If present, (meth)acrylic component suitable in Part B can be independently selected from those listed above for Part A, and can be the same as or different from that used in part A.

If present in part B, the (meth)acrylic component can be contained in an amount of from 5 to 65% by weight, such as, 6%, 8%, 10%, 12%, 15%, 18%, 20%, 25%, 28%, 30%, 35%, 38%, 45%, 50%, 55%, 60% by weight, based on the total weight of Part B.

All of the above defined amounts for each component are given with an assumption that part A is mixed with part B in a weight ratio of 1:1. If part A and part B are not used in 1:1 weight ratio, the above defined amounts can be adjusted accordingly to give a similar final mixing ratio of the components, and the adjusted amounts shall also be covered by the scope of the present invention.

### Other Components

In addition to the above-mentioned components, the adhesive composition of the present invention may optionally comprise other conventional additives in part A and/or part B, provided that the additive(s) in part A is/are not reactive to the components in part A and the additive(s) in part B is/are not reactive to the components in part B.

Specifically, part A does not contain amine-reactive ingredients and hydroxyl-reactive ingredients, and part B does not contain isocyanate-reactive ingredients and copper (II) reactive ingredients.

For example, part A and/or part B can contain rheology modifier(s) such as talcs, clays, carbon blacks and micas, fumed, precipitated, optionally silanized, silicas; antifoam(s) such as alcohols, hydrocarbons, paraffin-based mineral oils, glycol derivatives, acetic esters and polysiloxanes; stabilizer(s) such as UV stabilizers and free radical cure stabilizers (such as naphthaquinone and anthraquinone); dye(s); wetting agent(s); dispersing and levelling agent(s); antioxidant(s) such as hindered phenolic antioxidants, phosphite antioxidants and thioether antioxidants.

### Method for Bonding Substrates

The present invention provides a method of bonding substrates together using the adhesive composition of the present invention. The method includes mixing part A and part B, applying the mixture of part A and part B to at least one of the substrates, and then mating the substrates together, and then curing the mixture, for example, exposing the mated substrates to an elevated temperature of 30-100° C. for a specified time such as 1-150 min and then at room temperature for a specified time such as at least 10 hours.

The adhesive composition can be applied to a substrate using any suitable application method, and the adhesive composition can be applied as a continuous or discontinuous coating, in a single layer or multiple layers, and combinations thereof.

### Bonded Articles

The present invention provides an article bonded with the cured product of the adhesive composition of the present invention.

The adhesive composition of the present invention is useful in a variety of electronic devices including, e.g., wearable electronic devices (e.g., wrist watches and eyeglasses), handheld electronic devices (e.g., phones (e.g., cellular telephones and cellular smartphones), cameras, tablets, electronic readers, monitors (e.g., monitors used in hospitals, and by healthcare workers, athletes and individuals), watches, calculators, mice, touch pads, and joy sticks), computers (e.g., desk top and lap top computers), computer monitors, televisions, media players, appliances (e.g., refrigerators, washing machines, dryers, ovens, and microwaves), light bulbs (e.g., incandescent, light emitting diode, and fluorescent), and articles that include a visible transparent or transparent component, glass housing structures, protective transparent coverings for a display or other optical component.

### Examples

The invention will now be described by way of the following examples. The following examples are intended to assist one skilled in the art to better understand and practice the present invention. The scope of the invention is not limited by the examples but is defined in the appended claims. All parts and percentages are based on weight unless otherwise stated.

### Preparation of Adhesive Compositions

The adhesive compositions were prepared according to the components and amounts thereof listed in Table 1. Ingredients of each part were added into a mixing vessel with a lid and mixed in a Speedmixer DAC 150.1 FVZ—K for 10 mins at 2500 rpm. The formulations were then packed into 50 ml 1:1 mix ratio 2-part cartridges and filled up to piston height. The cartridges were centrifuged for 2 mins at 1500 rpm to remove bubbles. The pistons were then placed on the cartridges.

### Materials in Table 1:

PolyBD R20LM is a liquid hydroxyl terminated butadiene polymer, available from Cray Valley.
Sovermol 805 is a polyester/polyether polyol, available from BASF.
Multranol 4012 is a polypropylene oxide-based triol, available from Covestro LLC.
DABCO: 1,4-diazabicyclo[2.2.2]octane.
Loctite HHD6010 Part B is a polyisocyanate component, available from Henkel.
Eternathane 400U15 is a polyisocyanate component, available from UBE.
Kraton D1155ES is a linear block copolymer based on styrene and butadiene.
Hypro VTB 2000x168 is a reactive liquid polymer Methacrylate Terminated Butadiene from CVC Thermoset Specialties.
Wax is a paraffin wax.
Premix 1 comprises 5% Benzoquinone in Polyethyleneglycol dimethacrylate.
Premix 2 comprises 5% Tetrasodium ethylenediamine tetraacetic acid in a mixture of ethylene glycol and water (50/50 w/w).

TABLE 1

| | Comparative | | Comparative | | Comparative | | | |
|---|---|---|---|---|---|---|---|---|
| | Example 1 | | Example 2 | | Example 3 | | Example 1 | |
| | Part A | Part B | Part A | Part B | Part A | Part B | Part A | Part B |
| PolyBD R20LM | 11.1 | — | 11.1 | — | 11.3 | — | 11.3 | — |
| Sovermol 805 | 18.9 | — | 18.9 | — | 18.9 | — | 18.9 | — |
| Multranol 4012 | 18.5 | — | 18.5 | — | 18.5 | — | 18.5 | — |
| Dibtuyltin Dilaurate | 0.2 | — | — | — | — | 0.2 | — | — |
| DABCO | — | — | 0.2 | — | — | — | — | — |
| Loctite HHD6010 Part B | — | 47.5 | — | 46.2 | — | 46 | — | 46.2 |
| Kraton D1155ES | — | 10 | — | 9.8 | — | 9.8 | — | 9.8 |
| Methyl methacrylate | 8.3 | 39 | 8.3 | 38.1 | 8.3 | 38.1 | 8.3 | 38.1 |
| Copper Trifluoro- | — | 1 | — | 1 | — | 1 | — | 1 |
| acetylacetonate, | | | | | | | | |
| 10,000 ppm in MMA | | | | | | | | |
| solution | | | | | | | | |
| Methacrylic Acid | 9.7 | — | 9.7 | — | 9.7 | — | 9.7 | — |
| Hypro VTB 2000 × 168 | 23.4 | — | 23.4 | — | 23.4 | — | 23.4 | — |
| Saccharin | 0.5 | — | 0.5 | — | 0.5 | — | 0.5 | — |
| Acetylphenylhydrazine | 0.2 | — | 0.2 | — | 0.2 | — | 0.2 | — |
| Wax | 0.5 | — | 0.5 | — | 0.5 | — | 0.5 | — |
| Premix 1 | 1 | — | 1 | — | 1 | — | 1 | — |
| Premix 2 | 0.2 | — | 0.2 | — | 0.2 | — | 0.2 | — |
| Cumene Hydroperoxide | 2.4 | — | 2.4 | — | 2.4 | — | 2.4 | — |
| Hydrophobic Silica | 5.1 | 2.5 | 5.1 | 4.9 | 5.1 | 4.9 | 5.1 | 4.9 |
| Sum | 100 | 100 | 100 | 100 | 100 | 100 | 100 | 100 |
| | Example 2 | | Example 3 | | Example 4 | | Example 5 | |
| | Part A | Part B | Part A | Part B | Part A | Part B | Part A | Part B |
| PolyBD R20LM | 10.2 | — | 9.7 | — | 9.7 | — | 9.7 | — |
| Sovermol 805 | 17.3 | — | 16.2 | — | 16.2 | — | 16.2 | — |
| Trimethylolpropane | 17.0 | — | 16.8 | — | 16.7 | — | 16.8 | — |
| propoxylate | | | | | | | | |
| Loctite HHD6010 Part B | — | 47.5 | | — | — | 47.5 | — | 47.5 |
| Eternathane 400U15 | — | — | | 47.5 | — | — | — | — |
| Kraton D1155ES | — | 8.7 | | 9.3 | — | 9.3 | — | 9.3 |
| Methyl methacrylate | 11.1 | 34.8 | 11.5 | 37.2 | — | 37.2 | 11.6 | 37.2 |
| Copper Trifluoro- | — | 4.0 | | 1.0 | — | 1.0 | — | 1.0 |
| acetylacetonate, | | | | | | | | |
| 10,000 ppm in | | | | | | | | |
| MMA solution | | | | | | | | |
| Triethyleneglycol | | | | | 23.3 | | 11.6 | |
| dimethacylate | | | | | | | | |
| Methacrylic Acid | 11.2 | — | 11.7 | — | — | — | — | — |
| Hypro VTB 2000 × 168 | 23.9 | — | 24.8 | — | 24.8 | — | 24.8 | — |
| Saccharin | 0.5 | — | 0.5 | — | 0.5 | — | 0.5 | — |
| Acetylphenylhydrazine | 0.2 | — | 0.2 | — | 0.2 | — | 0.2 | — |
| Wax | 0.5 | — | 0.5 | — | 0.5 | — | 0.5 | — |
| Premix 1 | 0.5 | — | 0.5 | — | 0.5 | — | 0.5 | — |
| Premix 2 | 0.1 | — | 0.1 | — | 0.1 | — | 0.1 | — |
| Cumene Hydroperoxide | 2.5 | — | 2.5 | — | 2.5 | — | 2.5 | — |
| Hydrophobic Silica | 5.0 | 5.0 | 5.0 | 5.0 | 5.0 | 5.0 | 5.0 | 5.0 |
| Sum | 100 | 100 | 100 | 100 | 100 | 100 | 100 | 100 |

In these two-part compositions,
Comparative Example 1 contains in part A 0.2 wt % of dibutyltin dilaurate as a typical PU catalyst;
Comparative Example 2 contains in part A 0.2 wt % of DABCO as a typical PU catalyst;
Comparative Example 3 contains in part B 0.2 wt % of dibutyltin dilaurate as a typical PU catalyst;
Examples 1 to 5 do not contain any typical PU catalyst.

### Performance of Adhesives of Comparative Examples 1-5 and Examples 1-5 Stability

Compositions were prepared as stated above and kept at room temperature for 7 days to observe set-up of each part of the compositions, and the results are shown in Table 2:

TABLE 2

| | Comparative | | Comparative | | Comparative | | | |
|---|---|---|---|---|---|---|---|---|
| | Example 1 | | Example 2 | | Example 3 | | Example 1 | |
| | Part A | Part B | Part A | Part B | Part A | Part B | Part A | Part B |
| Set up before 7 | Yes | No | Yes | No | No | No | No | No |
| days at room | | | | | | | | |
| temperature? | | | | | | | | |

Table 3 shows that the inclusion of polyurethane catalysts in Part A containing APH, Saccharin and peroxide is not shelf life stable. These results show the limitations of the prior art (for example, US2019/0330432A1) in using combination of polyurethane catalysts with peroxides.

### Adhesion Strength

Adhesion tests were done according to ASTM D3163-01. The tests were done on stainless steel grade SUS304, 50% glass-filled polyamide lap shears and polybutylene terephthalate (PBT) material DuPont Crastin SK05. The adhesive in a 50 ml cartridge was dispensed through a static mixer nozzle. Bonds were made with a 0.5″ overlap and initially cured at 45° C. for 20 min, then followed by 24 hours at room temperature (RT) or seven days at room temperature. The results are shown in Tables 3-5.

TABLE 3
Lap shear strength on stainless steel

| | Lap Shear Strength Stainless Steel (MPa) | |
|---|---|---|
| | Cure Schedule | |
| | 45° C. for 20 min | 45° C. for 20m in |
| | then 24 h at RT | then 7 days at RT |
| Comparative Example 1 | 10.64 +/− 0.85 | 15 +/− 1.79 |
| Comparative Example 2 | 13.28 +/− 1.17 | 17.2 +/− 1.92 |
| Comparative Example 3 | 12.02 +/− 1.16 | 18.55 +/− 1.83 |
| Example 1 | 13.68 +/− 0.93 | 18.3 +/− 1.02 |
| Example 2 | 14.06 +/− 0.66 | 18.4 +/− 1.7 |
| Example 3 | 12.6 +/− 0.9 | 14.7 +/− 1.6 |
| Example 4 | Not tested | 15.4 +/− 0.7 |
| Example 5 | Not tested | 16.7 +/− 0.9 |

TABLE 4
Lap shear strength on polyamide

Lap Shear Strength Polyamide (MPa)
Cure Schedule

| | 45° C. for 20 min | 45° C. for 20 min |
|---|---|---|
| | then 24 h at RT | then 7 days at RT |
| Comparative Example 1 | 7.03 +/− 1.51 | 7.94 +/− 0.81 |
| Comparative Example 2 | 8.52 +/− 0.61 | 9.62 +/− 1.28 |
| Comparative Example 3 | 6.93 +/− 0.19 | 8.36 +/− 0.36 |
| Example 1 | 7.54 +/− 0.56 | 8.89 +/− 0.64 |
| Example 1 (primed with | 10.1 +/− 0.61 | 10.9 +/− 0.52 |
| Loctite SF770) | | |
| Example 2 (primed with | 12.4 +/− 0.35 | 12.2 +/− 0.60 |
| Loctite SF770) | | |
| Example 5 (primed with | Not tested | 10.3 +/− 0.78 |
| Loctite SF770) | | |

TABLE 5
Lap shear strength on PBT

Lap Shear Strength PBT (MPa)
Cure Schedule

| | 45° C. for 20 min | 45° C. for 20 min |
|---|---|---|
| | then 24 h at RT | then 7 days at RT |
| Comparative Example 1 | 2.56 +/− 0.12 | 3.88 +/− 0.52 |
| Comparative Example 2 | 2.15 +/− 0.23 | 2.64 +/− 0.16 |
| Comparative Example 3 | 2.11 +/− 0.15 | 3.26 +/− 0.34 |
| Example 1 | 2.92 +/− 0.14 | 5.3 +/− 0.28 |
| Example 2 | 2.56 +/− 0.07 | 3.7 +/− 0.2 |
| Example 3 | 2.9 +/− 0.2 | 3.0 +/− 0.3 |
| Example 4 | Not tested | 6.4 +/− 0.5 |
| Example 5 | Not tested | 8.8 +/− 0.8 |

Tables 3-5 show that even though Examples 1 to 5 does not contain a typical polyurethane catalyst, comparable or better adhesion strength was achieved compared with Comparative Examples containing the typical PU catalyst, both 24 h and 7 days after an initial mild heat cure.

### Toughness Performance

Impact resistance tests were done according to ISO 11343 “Adhesives—Determination of dynamic resistance to cleavage of high-strength adhesive bonds under impact conditions—Wedge impact method”. The test substrates were symmetric grit blasted DC-04 wedge coupons. The adhesives were applied as in the previous tests at an induced bond gap of 125 μm. Bonded test specimens were cured at 45° C. for 20 minutes followed by 24 hours at room temperature. The impact resistance can reflect the toughness of the cured composition. The test results are shown in Table 6.

TABLE 6
Dynamic resistance to cleavage of wedge impact test specimens
Dynamic Resistance to Wedge Impact, Grit Blasted Mild Steel (N/mm)

| Cure Schedule | 45° C. for 20 min then 24 h at RT |
|---|---|
| Comparative Example 1 | 10.19 +/− 1.75 |
| Comparative Example 2 | 10.32 +/− 1.94 |
| Comparative Example 3 | 5.77 +/− 0.37 |
| Example 1 | 15.53 +/− 0.86 |
| Example 2 | 15.91 +/− 2.28 |
| Example 3 | 21.3 +/− 1.8 |
| Example 4 | 21.9 +/− 1.2 |
| Example 5 | 23.0 +/− 3.0 |

Table 6 shows that surprisingly leaving typical polyurethane catalyst(s) out of the hybrid compositions while only using the cure system of the invention lead to significantly improved impact resistance.

Although some preferred embodiments have been described, many modifications and variations may be made thereto in light of the above teachings. It is therefore to be understood that the invention may be practiced otherwise than as specifically described without departing from the scope of the appended claims.

What is claimed is:

1. A two-part polyurethane-(meth)acrylic hybrid adhesive composition comprising:
Part A):
A1) a polyol;
A2) a cure accelerator selected from saccharin; saccharin derivatives in which the hydrogen atom in —NH— is substituted by a hydroxyl group or an alkoxy group; toluidines, such as N,N-diethyl-p-toluidine and N,N-dimethyl-o-toluidine; acetyl phenylhydrazine; compounds of formulae (1) and (2); and mixtures thereof; 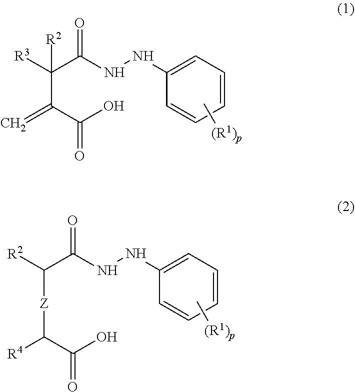
wherein R¹, R² and R³ in formula (1) and R¹, R² and R⁴ in formula (2) are each independently selected from H or C₁₋₄ alkyl; Z is a carbon-carbon single bond or carbon-carbon double bond; p is an integer of 1 to 5;
A3) a peroxide;
A4) optionally, a (meth)acrylic component;
Part B):
B1) a polyisocyanate,
B2) a copper (II) based catalyst,
B3) optionally, a (meth)acrylic component;
provided that the (meth)acrylic component is present in part A only, or in part B only or in both part A and part B.

2. The composition according to claim 1, wherein the (meth)acrylic component in part A and part B independently comprises a mono-functional (meth)acrylic monomer and/or a multi-functional (meth)acrylic monomer.

3. The composition according to claim 2, wherein the mono-functional (meth)acrylic monomer is selected from (meth)acrylic acid, n-butyl (meth)acrylate, 2-butyl (meth)acrylate, t-butyl (meth)acrylate, isobutyl (meth)acrylate, hexyl (meth)acrylate, 2-ethylhexyl (meth)acrylate, ethyl (meth)acrylate, methyl (meth)acrylate, n-propyl (meth)acrylate, isopropyl (meth)acrylate, pentyl (meth)acrylate, n-octyl (meth)acrylate, isooctyl (meth)acrylate, 2-methylbutyl (meth)acrylate, n-nonyl (meth)acrylate, isononyl (meth)acrylate, isoamyl (meth)acrylate, n-decyl (meth)acrylate, isodecyl (meth)acrylate, isobornyl (meth)acrylate, 4-methyl-2-pentyl (meth)acrylate, dodecyl (meth)acrylate, lauryl (meth)acrylate, tetrahydrofurfuryl (meth)acrylate, 2-ethoxylethyl (meth)acrylate, 2-methoxyethyl (meth)acrylate and allyl (meth)acrylate, 2-phenoxyethyl (meth)acrylate and mixtures thereof.

4. The composition according to claim 2, wherein the multi-functional (meth)acrylic monomer is selected from di-functional (meth)acrylic monomers such as 1,3-butanediol di(meth)acrylate, 1,4-butanediol di(meth)acrylate, 1,6-hexanediol di(meth)acrylate, 2-butyl-2-ethyl-1,3-propanediol di(meth)-acrylate, 1,9-nonanediol di(meth)acrylate, ethylene glycol di(meth)acrylate, bisphenol A-ethylene glycol di(meth)acrylate, diethylene glycol di(meth)acrylate, triethylene glycol di(meth)-acrylate, tetraethylene glycol di(meth)acrylate, propylene glycol di(meth)acrylate, dipropylene glycol di(meth)acrylate, tripropylene glycol di(meth)acrylate, neopentyl glycol di(meth)acrylate, dicyclopentanyl di(meth)acrylate, caprolactone-modified dicyclopentenyl di(meth)acrylate, di(acryloxyethyl)isocyanurate, allylated cyclohexyl di(meth)acrylate, dimethylol dicyclopentane di(meth)acrylate, neopentylglycol-modified trimethylolpropane di(meth)acrylate, adamantine di(meth)acrylate, tricyclodecanedimethanol di(meth)acrylate; tri-functional monomers such as trimethylolpropane tri(meth)acrylate, pentaerythritol tri(meth)acrylate, dipentaerythritol tri(meth)acrylate, propylene oxide-modified trimethylolpropane tri(meth)acrylate, tris(acryloxy-ethyl)isocyanurate; 4-functional monomers such as pentaerythritol tetra(meth)acrylate, ditrimethylolpropane tetra(meth)acrylate, tetramethylolpropane tetra(meth)acrylate; 5-functional monomers such as dipentaerythritol penta(meth)acrylate; 6-functional monomers such as dipentaerythritol hexa(meth)acrylate, and mixtures thereof.

5. The composition according to claim 1, wherein the polyol is selected from polyether polyols, polyester polyols and low molecular weight polyols.

6. The composition according to claim 1, wherein the peroxide is selected from sulphonyl peroxides, such as acetyl cyclohexane sulphonyl peroxide; percarbonates, such as dicyclohexyl peroxy dicarbonate; di-n-butyl peroxy dicarbonate and diisopropyl peroxy dicarbonate; peresters, such as tert-butyl peroxy pivalate, tert-butyl perneodecanoate and tert-butyl perbenzoate; diacyl peroxides, such as bis-(3,3,5-trimethylhexanoyl)-peroxide; dilauroyl peroxide; didecanoyl peroxide, dipropionyl peroxide; bis-(2,4-dichlorobenzoyl)-peroxide and dibenzoyl peroxide; dialkyl peroxides, such as dicumyl peroxide and di-tert-butyl peroxide; ketal peroxides, such as 1,1-di-tert.-butyl peroxy-3,3,5-trimethyl cyclohexane; alkyl hydroperoxides, such as cumene hydroperoxide, paramethane hydroperoxide and tert-butyl hydroperoxide, and ketone peroxides, such as cyclohexanone peroxideand ethyl methyl ketone peroxide.

7. The composition according to claim 1, wherein the polyisocyanate is selected from alkylene diisocyanates, cycloalkylene diisocyanates, aromatic diisocyanates and aliphatic-aromatic diisocyanates, polyester containing diisocyanates, polycarbonate containing diisocyanates, polyethylene glycol containing diisocyanates, polypropylene glycol containing diisocyanates, polytetramethyleneglycol ether containing diisocyanates, polycaprolactone containing diisocyanates and polyether containing diisocyanates.

8. The composition according to claim 1, wherein the copper (II) based catalyst is selected from copper trifluoroacetylacetonate, copper hexafluoroacetylacetonate, copper acetylacetonate, copper napthenate, copper octoate, copper tetrafluoroborate, copper salicyclate, copper sulfate, copper chloride, copper bromide, copper fluoride, copper methacrylate and copper triflate.

9. The composition according to claim 1, wherein total amount of the (meth)acrylic component in the adhesive composition is in the range of from 20 to 65% by weight based on the total weight of the adhesive composition.

10. The composition according to claim 1, wherein the polyol is contained in part A in an amount of from 10 to 70% by weight based on the total weight of part A.

11. The composition according to claim 1, wherein the cure accelerator is contained in part A in an amount of from 0.2 to 5% by weight, based on the total weight of part A.

12. The composition according to claim 1, wherein the peroxide is contained in part A in an amount of from 0.1 to 5% by weight based on the total weight of part A.

13. The composition according to claim 1, wherein the polyisocyanate is contained in part B in an amount of from 20-75% by weight based on the total weight of part B.

14. The composition according to claim 1, wherein the copper (II) based catalyst is contained in part B in an amount of from 1 to 5000 ppm based on the total weight of part B.

15. An article comprising the cured product of the adhesive composition according to claim 1.

16. A method of bonding two substrates together, the method including mixing part A and part B of the adhesive composition of claim 1, applying the mixture of part A and part B to at least one of the substrates, and mating the substrates together, and then curing the mixture.
